(19) United States
(12) Patent Application Publication
(10) Pub. No.: US 2010/0291512 A1
(43) Pub. Date: Nov. 18, 2010

(54) ROOT CANAL FILLER COMPOSED OF MINERAL TRIOXIDE AGGREGATE AND METHOD OF MANUFACTURING THE SAME

(75) Inventors: Jun Sang YOO, Seoul (KR); Tae Hyun Kim, Daejeon (KR)

Correspondence Address: AMPACC Law Group, 3500 188th Street S.W., Suite 103, Lynnwood, WA, 98037, US

(73) Assignees: Jun Sang YOO, Seoul (KR); Dio Corporation Limited, Daejeon (KR)

(21) Appl. No.: 12/780,814

(22) Filed: May 14, 2010

(30) Foreign Application Priority Data
May 15, 2009 (KR) 10-2009-0042660

(51) Int. Cl. A61C 5/02

(52) U.S. Cl. 433/224

(57) ABSTRACT

Disclosed is a root canal filler, which is powdery and is composed of mineral trioxide aggregate including a CaO—SiO₂—Al₂O₃ compound, with a residual CaO content of 0.7 wt % or less. This root canal filler is suitable for use in orthograde canal filling, prevents root fracture from occurring, is of very low impurity so as to exclude components hazardous to the human body, and has the property of being easy to introduce. A method of manufacturing the root canal filler is also provided.

### BACKGROUND OF THE INVENTION

1. Technical Field

The present invention relates to a root canal filler, and more particularly, to a root canal filler, which is powdery and is composed of mineral trioxide aggregate (MTA), so that it is adapted for orthograde canal filling in dental treatment, and to a method of manufacturing the same.

2. Description of the Related Art

Dental root canal fillers should be ideally superior in terms of biocompatibility, bactericidal properties, a sealing property, stability, workability, easy introduction and dispersion properties, setting time, enhanced tooth structure, homogeneity, and radiopacity.

Typical examples of the dental root canal fillers include gutta percha and sealer. The root canal treatment using gutta percha and sealer is referred to as an orthograde canal filling technique, which includes the following two methods.

FIG. 1 is a photograph showing a lateral condensation process which is a type of orthograde canal filling. With reference to FIG. 1, gutta percha cones B, C, D are placed in the root canal, and then laterally condensed using a spreader, thus filling the root canal. After filling, the empty space between the gutta percha and the root canal is filled with a sealer.

FIG. 2 shows a vertical condensation process which is another type of orthograde canal filling. With reference to FIG. 2, gutta percha is inserted into the root canal, and then vertically condensed using a plugger, so that the root canal is filled with the root canal filler.

However, treatments using gutta percha are basically disadvantageous because the initial sealing property of the apical region is seldom manifested and gutta percha is absorbed into the organism thus making it impossible to maintain the extended sealing property. Also, most sealers are cytotoxic in the initial setting step and show poor initial sealing properties such as foaming in the chamber of the canal system.

In particular, orthograde canal filling materials should hermetically seal an endodontic region to 5 mm from the root apex, namely, a root canal region to 5 mm from the root apex, without making gaps. However, conventional canal filling methods using gutta percha are poor in terms of the apical sealing effectiveness required to determine whether canal treatment clinically succeeds or fails.

In the case where a focus recurs on the apical region having been treated with the conventional root canal filler, the following retrograde canal filling method is carried out. FIG. 3 shows the retrograde canal filling process which includes the series of procedures of (i) incision of the anesthetized gum (A), (ii) exposure of the alveolar bone (C), (iii) exposure of the root apex of the focal region using a drill (D), (iv) anesthetization of the root apex (E), (v) resection of the root apex (F), (vi) perforation of the root apex (G), and (v) filling of the root apex with a filler (H).

This method is referred to as retrograde canal filling because the root canal is filled at the root apex unlike the orthograde canal filling method for filling the root canal at the top thereof. The retrograde canal filling material as is known to date is mainly exemplified by ProRoot available from DENTSPLY, USA. This material is a powdery root canal filler and thus shows better sealing effectiveness compared to when using gutta percha, and the composition thereof is MTA disclosed in U.S. Patent Application Publication No. 2004-226478.

The present inventors have applied ProRoot available from DENTSPLY, USA to orthograde canal filling and thus discovered that ProRoot does not exhibit satisfactory sealing effectiveness the region to 3 mm from the root apex. In addition, this filling material may cause root fracture after sealing of the root canal because it expands when setting, and may partially contain heavy metals such as chromium and may thus be regarded as bioincompatible (specifically, hexavalent chromium is detected in a small amount in the grey MTA but is not detected in the white MTA which is currently available).

### SUMMARY OF THE INVENTION

Accordingly, the present invention has been made keeping in mind the problems encountered in the related art and the present invention is intended to provide a root canal filler suitable for use in orthograde canal filling.

Also, the present invention is intended to provide a powdery root canal filler composed of MTA, which is able to hermetically seal the region to 3 mm from the root apex in orthograde canal filling.

Also, the present invention is intended to provide a powdery root canal filler composed of MTA, which is able to prevent root fracture due to expansion after treatment.

Also, the present invention is intended to provide a powdery root canal filler composed of MTA, which is biocompatible.

Also, the present invention is intended to provide an orthograde canal filling method using the above root canal filler.

As mentioned above, a conventional retrograde canal filling material composed of MTA, namely, ProRoot available from DENTSPLY, has a residual CaO content of 1.7 wt % or more which is comparatively high, undesirably causing a probability of cracking the filled canal region due to expansive pressure after a lapse of predetermined time. Also, gutta percha cannot completely seal the root apex after treatment, because of shrinkage. Hence, a newly developed powdery root canal filler composed of MTA should be able to appropriately shrink and expand.

According to the present invention, in order to prevent the powdery root canal filler composed of MTA from expanding, there is a need to control the residual CaO content thereof. More particularly, the root canal filler according to the present invention has a residual CaO content of 1.5 wt % or less, preferably 1.0 wt % or less, and more preferably 0.7 wt % or less.

On the other hand, because a root canal filler which is colored is poor in terms of aesthetic appearance after treatment, the whiteness of root canal filler should be increased. In order to increase the whiteness of the powdery root canal filler composed of MTA, the amount of impurities such as Fe₂O₃ in the starting materials should be lowered. However, if the amount of Fe₂O₃ is lowered, it is difficult to synthesize 3CaO—SiO₂. In the present invention, there is provided a powdery root canal filler composed of MTA, which inhibits impurities such as Fe₂O₃ and has 3CaO—SiO₂ in a sufficient amount.

Furthermore, the root canal filler according to the present invention may include as main components 3CaO.SiO₂, 2CaO.SiO₂ and 3CaO.Al₂O₃, these components being used in an amount of 95 wt % or more based on the total weight of a CaO—SiO₂—Al₂O₃ (MTA) compound.

Also, the powdery root canal filler composed of MTA typically contains a heavy metal component for radiography after filling. Thus, in the present invention, a radiopaque material is used, which includes a glass material such as strontium glass or barium glass, bismuth trioxide, barium sulfate (BaSO₄), and ytterbium fluoride (YbF₃). In the case of strontium glass, barium glass, bismuth trioxide and barium sulfate, material having an average particle size of 2 μm or less is useful, and in the case of ytterbium fluoride, material having a particle size of 200 nm or less, preferably 100 nm, and more preferably 40 nm is used. This component may be used in an amount of 20 parts by weight based on 100 parts by weight of the CaO—SiO₂—Al₂O₃ (MTA) compound.

In addition, the most important property required of the orthograde canal filling material is filling workability in the canal system. The term “filling workability” means that the root canal filler is easily introduced into the canal system and effectively seals the canal system. For this, such a material should have a uniform particle size distribution and a small particle size, without there being any coarse particles. Particularly useful in terms of outstanding material properties are spherical particles. The powdery root canal filler composed of MTA according to the present invention may have an average particle size of 1˜5 μm, without coarse particles larger than 10 μm. In particular, the powdery root canal filler composed of MTA according to the present invention may have an average particle size of 0.1˜2 μm, without coarse particles larger than 5 μm. Such small particles may be effective in hermetically sealing the canal region to 5 mm from the root apex after filling.

Furthermore, the root canal filler according to the present invention should be biocompatible and should be able to ensure an extended bactericidal property. Such a root canal filler may be regarded as an ideal dental root canal filler when accelerating the differentiation of various blast cells to thus drastically aid the treatment of the apical region.

The present invention provides a dental root canal filler as described below, and an orthograde canal filling method using the same.

According to the present invention, there is provided a powdery root canal filler composed of MTA including a CaO—SiO₂—Al₂O₃ compound, the root canal filler having a residual CaO content of 1.5 wt % or less. The root canal filler includes as main components 3CaO.SiO₂,2CaO.SiO₂ and 3CaO.Al₂O₃, these components being used in an amount of 95 wt % or more based on the total weight of the CaO—SiO₂—Al₂O₃ compound. Also, the root canal filler according to the present invention may further include a bismuth-based radiopaque material. In the present invention, the residual CaO content is preferably 0.7 wt % or less. The powdery root canal filler composed of MTA according to the present invention may have an average particle size of 1˜5 μm, and a maximum particle size of 10 μm or less. Particularly, the powdery root canal filler may have an average particle size of 0.1˜2 μm, and a maximum particle size of 5 μm or less.

In addition, the present invention provides a method of manufacturing a root canal filling reagent including mixing the powdery root canal filler composed of MTA with water in an amount adapted to hydrate the root canal filler, and then centrifuging the mixture. As such, the mixing ratio by weight of the water and the root canal filler may fall in the range of 0.3˜1.0.

In addition, the present invention provides a method of manufacturing the powdery root canal filler composed of CaO—SiO₂—Al₂O₃ (MTA), including providing CaO, SiO₂ and Al₂O₃ as starting materials, mixing and burning the starting materials, milling the burned body and sieving the milled particles thus obtaining the powdery root canal filler composed of MTA, having a maximum particle size of 10 μm or less.

Also, this method may further include mixing the milled root canal filler with a bismuth-based radiopaque material.

In addition, the present invention provides an orthograde canal filling method, including enlarging the root canal of a tooth, mixing water with the powdery root canal filler composed of CaO—SiO₂—Al₂O₃ (MTA) and having a residual CaO content of 1.5 wt % or less, centrifuging the mixture, pushing the centrifuged root canal filler toward the root apex through the canal orifice thus sealing the root apex, filling the root canal with the root canal filler, and setting the root canal filler.

### BRIEF DESCRIPTION OF THE DRAWINGS

The features and advantages of the present invention will be more clearly understood from the following detailed description taken in conjunction with the accompanying drawings, in which:

FIG. 1 is a photograph showing a lateral condensation process which is a type of orthograde canal filling;

FIG. 2 is a photograph showing a vertical condensation process which is another type of orthograde canal filling;

FIG. 3 is a view showing a series of procedures of retrograde canal filling;

FIG. 4 is an electron micrograph showing the root canal filler powder of Example 1;

FIG. 5 is an electron micrograph showing the root canal filler powder of Example 2;

FIG. 6 is an electron micrograph showing the root canal filler powder of Comparative Example 1;

FIG. 7 is an electron micrograph showing the root canal filler powder of Comparative Example 2;

FIGS. 8 and 9 are graphs of results of quantitative X-ray diffraction analysis (QXRD) of Examples 1 and 2, respectively;

FIGS. 10 and 11 are graphs of results of QXRD of Comparative Examples 1 and 2, respectively;

FIGS. 12 to 19 are optical micrographs showing cross-sections of respective segments of the region at 1˜8 mm from the root apex in Test Example 1;

FIGS. 20 to 28 are optical micrographs showing cross-sections of respective segments of the region at 1˜10 mm from the root apex in Test Example 2;

FIGS. 29 to 36 are optical micrographs showing cross-sections of respective segments of the region at 1˜8 mm from the root apex in Test Example 3; and

FIGS. 37 to 45 are optical micrographs showing cross-sections of respective segments of the region at 1˜9 mm from the root apex in Test Example 4.

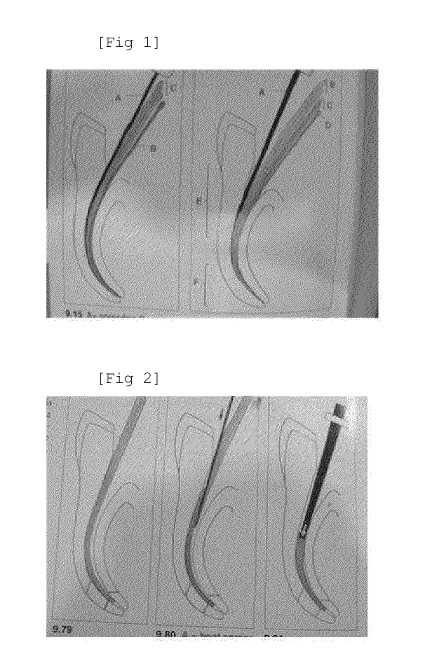

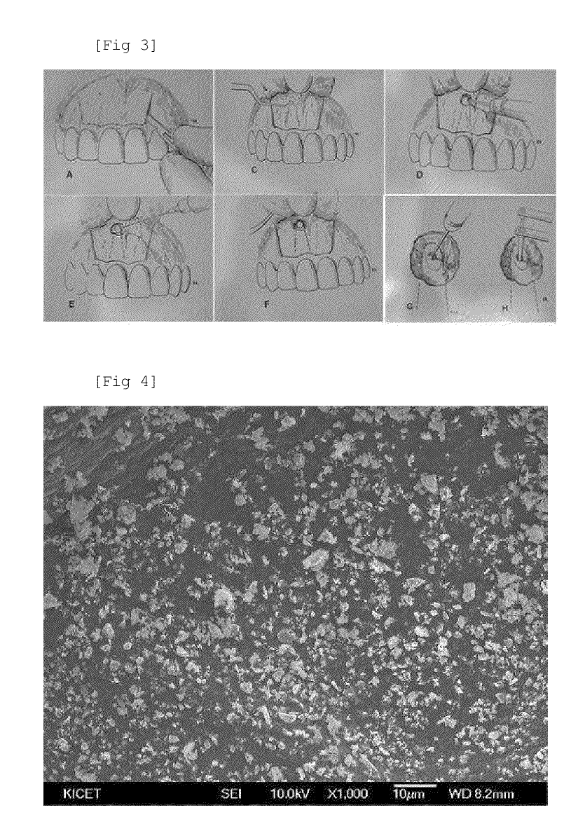

### DESCRIPTION OF SPECIFIC EMBODIMENTS

Hereinafter, a detailed description will be given of the present invention.

The present invention provides a root canal filler, which is powdery and is composed of MTA including a CaO—SiO₂—Al₂O₃ compound with 3CaO.SiO₂,2CaO.SiO₂ and 3CaO.Al₂O₃ as main components. This filler is designed so as to be adapted for orthograde canal filling. Specifically, starting materials of the powdery root canal filler composed of MTA are mixed and burned under conditions able to maximally inhibit the production of residual CaO therefrom, so that the powdery root canal filler composed of MTA maintains the dimensional change following setting to an appropriate level, improves whiteness, facilitates treatment and filling workability, and manifests a bactericidal property and biocompatibility.

In the case of conventional root canal filler composed of MTA, it has a residual CaO content of 1.7 wt % or more which is comparatively high, undesirably causing a probability that the root canal region having been subjected to root canal filling will crack due to expansive pressure after a predetermined time has elapsed. For this reason, in the use of the root canal filler composed of MTA, the dimensional change following setting is regarded as very important. Also, the shrinkage and expansion of the root canal filler composed of MTA should be as small as possible. In particular, shrinkage after treatment results in a poor sealing property in the root canal, whereas expansion after treatment results in a cracked root. The production of residual CaO is affected by the mixing conditions of the starting materials and the burning temperature and time. Furthermore, when a dental root canal filler is colored, aesthetic appearance becomes poor, and thus the whiteness of materials should be increased as much as possible. In order to increase whiteness, Fe₂O₃ should not be used as a starting material, and the use of a white radiopaque material is more effective. The radiopaque material may be used in an appropriate amount, that is, about 20 parts by weight based on 100 parts by weight of the root canal filler.

Moreover, in order to achieve efficient root canal filling, filling workability is very important. With the goal of improving filling workability, the root canal filler should be easily dispersed and introduced, which results from the powdery root canal filler composed of MTA having a relatively uniform particle size distribution and an average particle size as small as possible, without coarse particles. Such properties may depend on the milling conditions of the burned root canal filer. Also, the powdery root canal filler composed of MTA should have superior biocompatibility and a superior bactericidal property. Also, the powdery root canal filler composed of MTA accelerates the differentiation of various blast cells and thus should drastically aid the treatment of the apical region.

In the present invention, orthograde canal filling (which is called Dr Yoo's Orthograde Filling Technique by the present inventors) indicates a novel root canal filling method which enables orthograde filling of the root canal using the powdery root canal filler. The orthograde canal filling method according to the present invention is carried out by (1) measuring a root canal length of a tooth to be treated, (2) enlarging the root canal of the tooth to facilitate the treatment, (3) cleaning the root canal of the tooth so as to prevent bacterial infection and to facilitate treatment, (4) drying the root canal of the tooth, (5) mounting a vial of the powdery root canal filler composed of MTA according to the present invention into a small centrifugal machine, adding an appropriate amount [e.g. water/power (w/p)=0.3˜1.0] of 9% physiological saline or phosphate buffered solution (PBS, which is more favorable than physiological saline upon treatment), and then performing centrifuging, in which the separated water is removed using a swab and so on, (6) transporting the mixed root canal filler to the canal orifice using a carrier, (7) pushing the mixed root canal filler into the canal orifice, (8) pushing the root canal filler toward the root apex using a plugger, (9) repeating the procedures (3) and (4) so that the root canal filler is charged up to the canal orifice, and then pushing a spreader into the root canal until the tip of the spreader arrives at 0.5 mm from the root apex, (10) mounting a condenser onto a dental low-speed angle and then accurately pushing it into the root canal as long as the root canal length, (11) filling the root canal with the root canal filler at a low speed of about 1500˜2000 rpm until feeling as if the tip of the condenser hits a hard object such as a glass plate, so that the root apex is hermetically sealed, (12) sealing the root canal using the root canal filler as long as a length resulting from subtracting about 5 mm from the root canal length, so that the region up to 5 mm from the root apex is sealed with the root canal filler, (13) performing back filling using a plugger, (14) forming a space for forming a post in the root canal using high speed bur, and (15) forming a post core through a direct process or an indirect process.

The orthograde canal filling method according to the present invention has properties different from those of the conventional canal filling method, which are described below.

Specifically, first, the orthograde canal filling method according to the present invention is a permanent canal filling method using powder. Because of the use of powder, the canal system may be completely filled without gaps.

Second, the powder shows a dimensional change following setting of 0.1% or less. When currently available ProRoot MTA which has a large size change rate, namely, a large dimensional change following setting, is used as the orthograde canal filling material, there is a danger of causing root fracture. However, because the root canal filler according to the present invention may maintain the dimensional change following setting to 0.1% or less, it may be employed in orthograde filling of the root canal.

Third, the biological properties of the powder induce the regeneration of the apical region. Thorough research into the effect of MTA based material on the apical tissue has been conducted. In particular, the reproduction of bone tissue, periodontal membrane tissue and cementum is induced, consequently enabling the regeneration of the periodontium of the apical region.

Fourth, a specific powder transporting instrument may be used to transport powder to the canal orifice. The root canal filler according to the present invention, which shows hydraulic properties, should not adhere to the transporting instrument, and may be made of a material such as a Teflon tube.

Fifth, in order to perform orthograde canal filling using the powder, a special dental drill such as a condenser may be used. The condenser enables the region to 5 mm from the root apex to be completely filled with the hydraulic root canal filler power transported to the canal orifice without gaps while the condenser rotates toward the root apex at a uniform speed.

Sixth, the hydration of the powder is different from conventional dental cement mixing. To efficiently use powder upon treatment, the root canal filler powder is hydrated in PBS and is simultaneously mixed with a small amount of Vaseline or glycerin, after which a 0.6 cc vial containing the resulting paste is centrifuged in a small centrifugal machine thus compacting the root canal filler powder to be without gaps. Thereafter, the upper ⅔ portion of the vial is cut using scissors for easy working by the Teflon tube of the root canal filler transporting instrument.

Seventh, directly after filling the root canal with the powder, the root canal may be removed to form a metal post, a dental impression may be formed, or a post resin core may be formed thus enabling the removal of a tooth to form a crown. Ultimately, the number of visits may be reduced.

Eighth, apical inflammation is alleviated or eliminated due to alkalinity of the powder, thus drastically reducing teeth mobility.

Ninth, because of biocompatibility of the powder, the tapping reaction after treatment is seldom caused unlike conventional treatment.

A better understanding of the present invention may be obtained by the following examples which are set forth to illustrate, but are not to be construed as limiting the present invention.

Properties of Root Canal Filler

### Example 1

71 parts by weight of CaO resulting from calcination (decarbonation) of CaCO₃ at 1000° C. was mixed with 25 parts by weight of SiO₂ and 4 parts by weight of Al₂O₃, after which the resulting mixture was placed in a platinum crucible and burned at 1450° C. for 8 hours. The burned mixture was milled using a mill such as a planetary mill at room temperature, and then sieved so that particles larger than 5 μm were removed, after which the remaining particles were mixed with a predetermined amount of bismuth-based radiopaque material and then sufficiently stirred, thus obtaining homogeneously mixed root canal filler powder. The powder thus obtained was subjected to QXRD using PW 1710 available from Philips, Netherlands. As such, the measurement conditions were 2⊖=5˜60°, scan speed=4°/min, target=Cu kα₁, power=40 kV, 30 mA. Furthermore, the average particle size of the powdery root canal filler composed of MTA was measured using Mastersizer 2000 available from Malvern. The powder state, including the size and shape of the particles, of the root canal filler according to the present invention was observed with the naked eye and using a scanning electron microscope (SEM), and the residual CaO content in the prepared powder was measured according to ISO 680. The physicochemical tests for flow, working time, setting time, film thickness, solubility, dimensional change following setting, and radiopacity of the finally prepared powdery root canal filler composed of MTA were performed according to ISO 6876.

### Example 2

The same materials as in Example 1 were used, with the exception of the mixing ratio thereof being changed. Specifically, 68 parts by weight of CaO resulting from calcination (decarbonation) of CaCO₃ at 1000° C. was mixed with 26 parts by weight of SiO₂ and 6 parts by weight of Al₂O₃, after which the resulting mixture was placed in a platinum crucible and burned at 1450° C. for 8 hours. The burned mixture was milled using a planetary mill at room temperature, and then sieved so that particles larger than 5 μm were removed, after which the remaining particles were mixed with a predetermined amount of bismuth-based radiopaque material and then sufficiently stirred, thus obtaining homogeneously mixed root canal filler powder. The powder thus obtained was subjected to QXRD, particle size measurement, SEM observation, and analysis of residual CaO content. The properties of the powder were evaluated as in Example 1.

### Example 3

The same materials as in Example 1 were used, and milled to have a larger average particle size compared to Example 1, and particles larger than 10 μm were removed. The average particle size in Example 3 is shown in Table 3 below.

### Example 4

The same materials as in Example 1 were used, and milled to have a larger average particle size compared to Example 3, and particles larger than 10 μm were removed. The average particle size in Example 4 is shown in Table 3 below.

### Comparative Example 1

For comparison with Examples 1 and 2, commercially available white portland cement was subjected to QXRD, particle size measurement, SEM observation, and analysis of residual CaO content. The properties of the powder were evaluated as in Example 1.

### Comparative Example 2

For comparison with Examples 1 and 2, commercially available ProRoot MTA from DENTSPLY was subjected to QXRD, particle size measurement, SEM observation, and analysis of residual CaO content. The properties of the powder were evaluated as in Example 1.

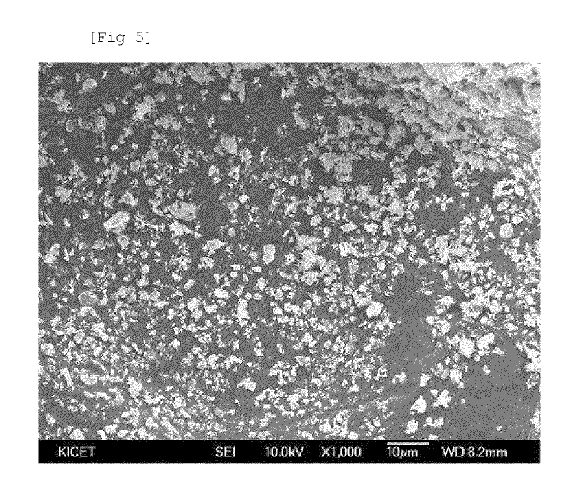

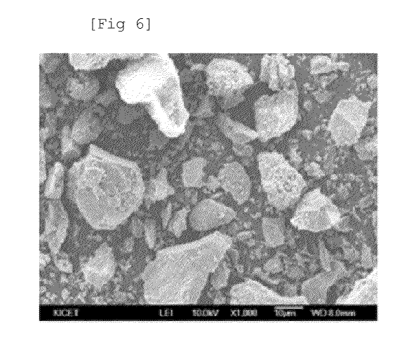

FIGS. 4 to 7 are SEM images showing the powder state of the root canal fillers of Examples 1 and 2 and Comparative Examples 1 and 2. As shown in these drawings, the root canal filler powder composed of MTA of the examples can be seen to have particles which are smaller and more uniform compared to the particles of the comparative examples. The root canal filler powder composed of MTA of the examples can also seen to have a relatively higher sphericity compared to the powder of the comparative examples.

### Evaluation of Properties of Root Canal Filler

According to ISO 6876:2001 [Dental root canal sealing materials], a physicochemical evaluation was conducted for the flow, working time, setting time, film thickness, solubility, dimensional change following setting, and radiopacity.

<Evaluation of Flow>

The root canal filler powder of Examples 1 and 2 and Comparative Examples 1 and 2 was mixed with water (0.9% physiological saline) at a ratio (water/powder) of 0.3˜1.0, after which the mixed sample was loaded into a graduated syringe (capacity 0.5 ml, graduations 0.01 ml), and 0.05 ml (±0.0005 ml) of the mixed sample was placed on a glass plate (40 mm×40 mm×5 mm) having a polished surface. 180±5 seconds after mixing, an additional glass plate having the same size was overlaid on the center of the glass plate on which the 0.05 ml sample had been placed, and a force of 100 g weight was applied in the direction of gravity onto the glass plates using a balance weight (100 g). 10 min after initiation of mixing, the balance weight was removed from the glass plates and the maximum and minimum diameters of the 0.05 ml sample spread radially by compression were measured and averaged. If the difference in the average value between the maximum diameter and the minimum diameter was 1 mm or more, the test was conducted again. Three measurements were performed in the same manner, and the obtained values were averaged, thus determining the flow (unit=mm).

<Evaluation of Working Time>

The root canal filler powder of Examples 1 and 2 and Comparative Examples 1 and 2 was mixed with water (0.9% physiological saline) at a ratio (water/powder) of 0.3˜1.0, after which the mixed sample was loaded into a graduated syringe (capacity 0.51 ml, graduations 0.01 ml), and 0.05 and of the mixed sample was placed on a glass plate (40 mm×40 mm×5 mm) having a polished surface. 210±5 seconds after mixing, an additional glass plate having the same size was overlaid on the center of the glass plate on which the 0.05 and sample had been placed, and a force of 100 g weight was applied for 7 minutes in the direction of gravity using a balance weight (100 g) onto the glass plates including the 0.05 ml sample. Thereafter, the maximum and minimum diameters of the sample spread radially by compression were measured. Also, the sample was mixed with a hydrating agent and then tested in the same manner, and this test was repeated while gradually increasing the time ranging from initiation of mixing to application of force until the flow value was 10% lower than the previously measured flow value.

<Evaluation of Setting Time (Under Conditions of not Requiring Moisture Upon Setting)>

A metal block (8 mm×20 mm×10 mm) was previously placed in a thermohygrostat at 37° C. and a relative humidity of 95% or more. A stainless steel split-ring mold (diameter=10 mm, height=2 mm) was placed on a microscopic slide glass about 1 mm thick. The root canal filler powder of Examples 1 and 2 and Comparative Examples 1 and 2 was mixed with water (0.9% physiological saline) at a ratio (water/powder) of 0.3-1.0, after which the mixed sample was loaded into a graduated syringe (capacity 0.5 ml, graduations 0.01 ml), and then charged up to the surface of the prepared mold. 120±10 seconds after mixing, a sample (mold+mixed sample) was placed on the metal block having been previously placed in the thermohygrostat. Thereafter, whether setting was completed was measured in such a way that slow descending of a needle on the sample was repeated until indentation was not formed on the surface of the sample using a Gilmore indentation inspector, and the time elapsed from the initial mixing time was recorded. The same test was repeated three times, and the obtained values were averaged, thus determining the setting time.

<Evaluation of Film Thickness>

The total thickness of two glass plates (minimum area in contact with each other=200 mm², thickness 5 mm) the surfaces of which were polished and on which the sample was not applied was measured to an accuracy of 1 μm using a micrometer (available from Mitutoyo) or an indicator. The root canal filler powder of Examples 1 and 2 and Comparative Examples 1 and 2 was mixed with water (0.9% physiological saline) at a ratio (water/powder) of 0.3˜1.0, after which the mixed sample was loaded into a graduated syringe (capacity 0.5 ml, graduations 0.01 ml) and 0.05 ml of the mixed sample was placed on the center of one glass plate, and was overlaid with the other glass plate having the same size. 180±10 seconds after initiation of mixing, a force of 150 N was applied in the direction of gravity so that the entire area of the glass plates in contact with each other was covered with the 0.05 ml compressed sample. 10 minutes after initiation of mixing, the total thickness of the two glass plates was measured, from which the thickness of only the compressed and spread sample was determined. The same test was repeated three times and the obtained values were averaged, thus determining the film thickness (unit=μm).

<Evaluation of Solubility (Under Conditions of not Requiring Moisture Upon Setting)>

The root canal filler powder of Examples 1 and 2 and Comparative Examples 1 and 2 was mixed with water (0.9% physiological saline) at a ratio (water/powder) of 0.3˜1.0, after which the mixed sample was loaded into a graduated syringe (capacity 0.5 ml, graduations 0.01 ml). Two stainless steel split-ring molds (diameter=20±1 mm, height=1.5±0.1 mm) were placed on a polished flat glass plate (which should be larger than the maximum size of the split-ring mold), and then filled with the mixed sample. An additional glass plate having a polyethylene (PE) film (thickness=50±30 μm) attached thereto was pressed on the sample so that the surface of the sample was flat and uniform, followed by cautiously removing the film. The molds filled with the mixed sample were placed in a thermohygrostat at 37° C. and a relative humidity of 95% and stored for a period of time 50% longer than setting time.

Thereafter, the weights of two specimens removed from the molds and a glass petri dish (diameter=90 mm, volume=50 ml) were measured to an accuracy of 0.001 g. The two specimens were placed in the glass petri dish so that their surfaces did not come into contact with each other, followed by adding 50 ml of water and then capping the glass petri dish. The glass petri dish and the specimens were stored at 37±1° C. for 24 hours, and then only the specimens were removed. As such, the specimens were washed with a slight amount of water, so that the water containing the surface remainder was added into the petri dish. Thereafter, water in the dish was evaluated at 110±2° C. while not being boiled, and the dish from which water had been evaporated was cooled in the air and then weighed to an accuracy of 0.001 g. The solubility was calculated by the following equation, and the overall procedure was repeated three times, and the obtained values were averaged, thus determining the solubility.

Solubility (%)=[(weight of dish after evaporation−weight of dish before evaporation)/initial weight of two specimens]×100

<Evaluation of Radiopacity>

The root canal filler powder of Examples 1 and 2 and Comparative Examples 1 and 2 was mixed with water (0.9% physiological saline) at a ratio (water/powder) of 0.3˜1.0, after which the mixed sample was loaded into a graduated syringe (capacity 0.51 ml, graduations 0.01 ml), and then a stainless steel split-ring mold (diameter=10 mm, height=1 mm) was filled therewith. The top and bottom of the mold were capped and pressed, thus preparing a specimen having a thickness of 1 mm. The specimen and an aluminum step wedge were located nearby on a stand. The specimen was exposed at 10 mA for 0.1 seconds (the time period at which the optical density of the film around the specimen and the aluminum after development was 1.5˜2) with X-rays of 65±5 kV at a target-film distance of 300 mm.

<Evaluation of Dimensional Change Following Setting (Under Conditions of not Requiring Moisture Upon Setting)>

The root canal filler powder of Examples 1 and 2 and Comparative Examples 1 and 2 was mixed with water (0.9% physiological saline) at a ratio (water/filler powder) of 0.3˜1.0, after which a microscopic slide glass (25 mm×75 mm×1 mm), a PE film (thickness=50±30 μm) and a stainless steel split-ring mold (diameter=6 mm, height=12 mm) were mounted in that order, and 2 g of the mixed sample was then charged in the mold so as to slightly overflow from the upper surface of the mold. Furthermore, the mold was capped with a PE film and a microscopic slide glass in that order, and the microscopic slide glasses and the mold were fixed together by means of a C-clamp (clamped width=25 mm). 5 minutes after initiation of mixing, all the fixed slide glasses/mold/C-clamp were placed in a thermohygrostat at a temperature of 37±1° C. and a humidity of 95˜100%. The mixed sample was set for the setting time and then removed from the thermohygrostat, after which the mold containing the sample was placed in a vertical direction on polishing paper (particle size #600) and then moved back and forth, so that the edge of the sample was polished. Subsequently, the mold was removed, and the diameter of the polished sample was measured to an accuracy of 10 μm, after which the sample was stored in distilled water at 37±1° C. up to the following measurement. 30 days after manufacture of the specimen, the length of the specimen was measured to an accuracy of 10 μm, and the dimensional change (unit=%) was determined according to the following equation.

[Dimensional change following setting (%)=[(specimen length after 30-day immersion−initial specimen length)/initial specimen length]×100]

The results of QXRD of residual CaO content in Examples 1 and 2 and Comparative Examples 1 and 2 are shown in Table 1 below.

TABLE 1

| | Ex. 1 | Ex. 2 | C. Ex. 1 | C. Ex. 2 |
|---|---|---|---|---|
| Residual CaO (wt %) | 0.66 | 0.84 | 1.65 | 1.74 |

As is apparent from the above table, the residual CaO content in Examples 1 and 2 according to the present invention can be seen to be below 1.0 wt %, which corresponds to about ½ or less of 1.65 wt % and 1.74 wt % in Comparative Examples 1 and 2, respectively.

According to the present invention, the root canal filler has low residual CaO content and starting materials of low impurity, and thus the crystalline phase content thereof is very high.

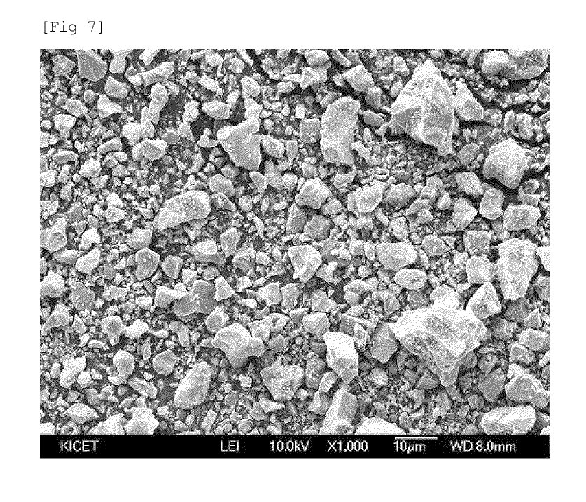

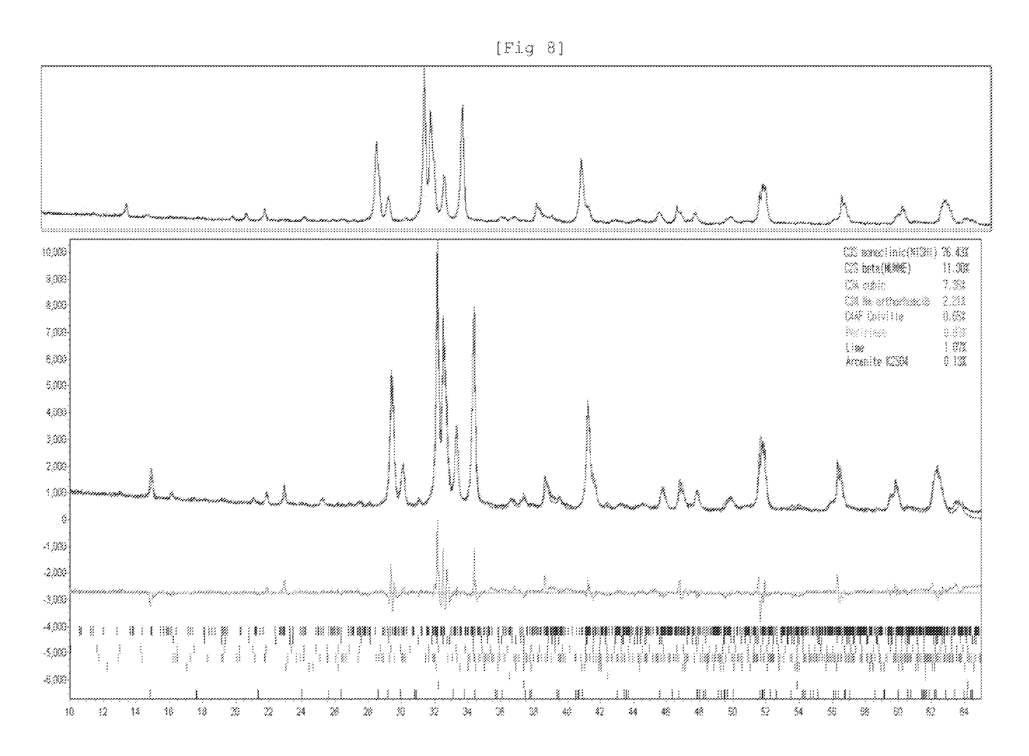

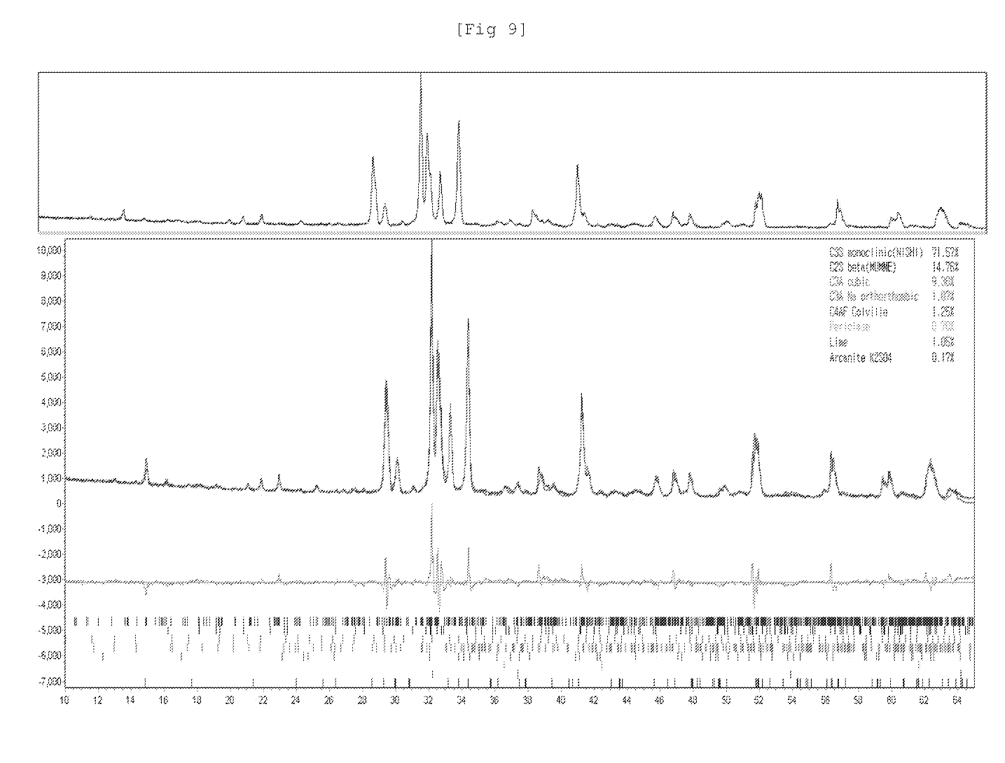

FIGS. 8 to 11 are graphs showing QXRD results of Examples 1 and 2 and Comparative Examples 1 and 2. The amounts of 3CaO.SiO₂,2CaO.SiO₂ and 3CaO.Al₂O₃ represented by wt % are shown in Table 2 below.

TABLE 2

| | Ex. 1 | Ex. 2 | C. Ex. 1 | C. Ex. 2 |
|---|---|---|---|---|
| 3CaO•SiO₂ | 76 | 72 | 54 | 66 |
| 2CaO•SiO₂ | 12 | 13 | 20 | 7 |
| 3CaO•Al₂O₃ | 8 | 10 | 17 | 20 |
| Total | 96 | 95 | 91 | 93 |

As is apparent from the above table, the crystalline phase content can be seen to be higher in Examples 1 and 2 than in Comparative Examples 1 and 2.

Also, the average particle size of the root canal fillers of Examples 1 to 4 and Comparative Examples 1 and 2 is shown in Table 3 below.

TABLE 3

| | Ex. 1 | Ex. 2 | Ex. 3 | Ex. 4 | C. Ex. 1 | C. Ex. 2 |
|---|---|---|---|---|---|---|
| Average | 1.1 | 1.6 | 3.5 | 3.9 | 11.4 | 6.9 |
| particle size (μm) | | | | | | |

As is apparent from the above table, the particle size of the root canal fillers of the examples can be seen to be smaller than those of Comparative Examples 1 and 2.

The dimensional changes following setting depending on the setting time in Examples 1 and 2 and Comparative Examples 1 and 2 are shown in Table 4 below.

TABLE 4

| | | Elapsed Time (day) | | | |
|---|---|---|---|---|---|
| | Specimen length (mm) | 1 | 3 | 7 | 28 |
| Ex. 1 | 12.04 | 0.05 | 0.04 | 0.08 | 0.08 |
| Ex. 2 | 12.11 | 0.06 | 0.05 | 0.08 | 0.09 |
| C. Ex. 1 | 12.04 | 0.12 | 0.27 | 0.36 | 0.52 |
| C. Ex. 2 | 12.07 | −0.07 | 0.10 | 0.28 | 0.31 |

As is apparent from the above table, the dimensional changes following setting of the root canal fillers of Examples 1 and 2 can be seen to be much lower than those of Comparative Examples 1 and 2 at the 28^{th} day. This is considered to be due to the low CaO content in Examples 1 and 2.

The flow and film thickness depending on the setting time in Examples 1 and 2 and Comparative Examples 1 and 2 are shown in Table 5 below.

TABLE 5

| | Ex. 1 | Ex. 2 | C. Ex. 1 | C. Ex. 2 |
|---|---|---|---|---|
| Flow (mm) | 21.8 | 24.2 | 8.8 | 10.0 |
| Film thickness (μm) | 25 | 27 | 312 | 208 |

As is apparent from the above table, the root canal fillers of Examples 1 and 2 can be seen to be higher in terms of flow and lower in terms of film thickness, compared to those in Comparative Examples 1 and 2. This is considered to be because the particle size of Examples 1 and 2 is smaller than that of Comparative Examples 1 and 2.

The working time depending on the setting time and the setting time in Examples 1 and 2 and Comparative Examples 1 and 2 are shown in Table 6 below.

TABLE 6

| | Ex. 1 | Ex. 2 | C. Ex. 1 | C. Ex. 2 |
|---|---|---|---|---|
| Working | 12 min | 12 min | 10 min 30 sec | 11 min 00 sec |
| time | | | | |
| Setting | 5 hr 30 min | 5 hr 30 min | 3 hr 50 min | 3 hr 50 min |
| time | | | | |

As is apparent from the above table, the working time of the root canal fillers of Examples 1 and 2 is shorter than 30 minutes which is the standard working time and thus these fillers are stable, and the setting time thereof is shorter than 72 hours which is the standard time, and are thus evaluated to be very good.

TABLE 7

| | Ex. 1 | Ex. 2 | C. Ex. 1 | C. Ex. 2 |
|---|---|---|---|---|
| Solubility | 1.2% | 1.3% | 1.1% | 1.3% |

As is apparent from the above table, the solubility of the root canal fillers of Examples 1 and 2 is lower than that of Comparative Example 2. After treatment, the root canal filler according to the present invention is anticipated to be stably stored thus improving sealing effectiveness.

Sealing Effectiveness Test

### Test Example 1

### Use of Gutta Percha and Sealer

Using conventional gutta percha (Gutta Percha Point, available from META BIOMED) and ZOE-based sealer (Z.O.B SEAL, available from META BIOMED), root canal filling was tested. Specifically, a test tooth was subjected to root canal enlargement according to a typical method, and then to root canal filling using gutta percha and sealer. After canal filling, the region to 2 mm from the root apex was immersed in a dyeing solution for 6 hours and then dried. The dried tooth was segmented in units of 1 mm/2 mm/ . . . /10 mm from the root apex, and the cross-sections of respective segments were observed with a digital optical microscope (200 magnifications).

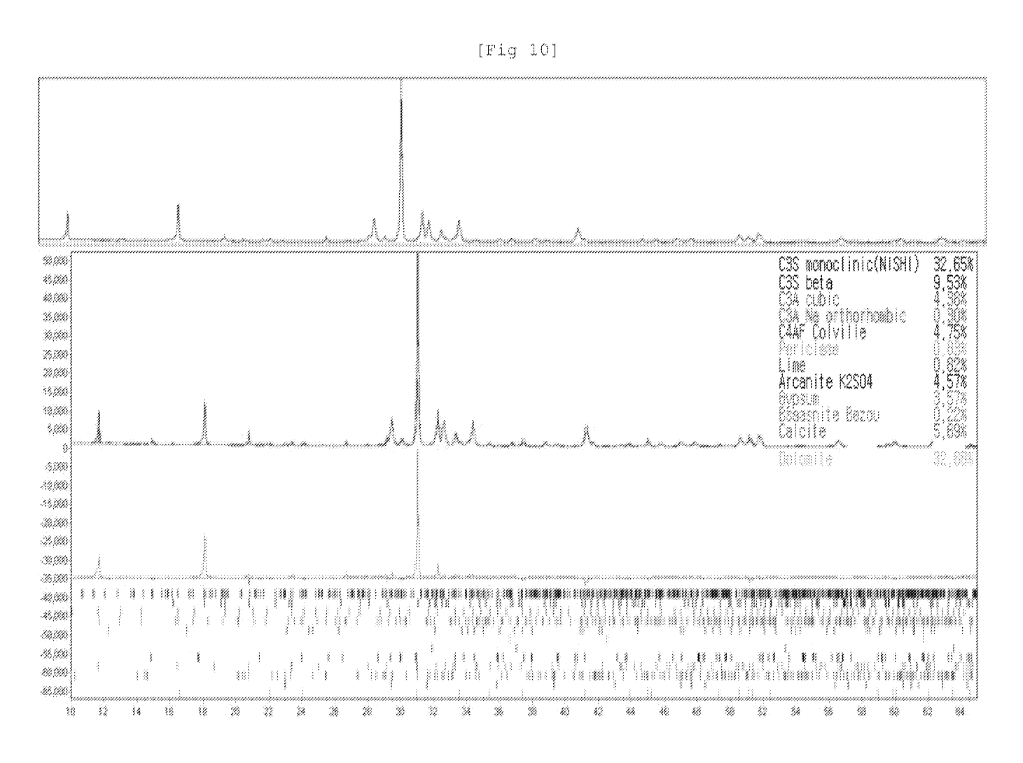

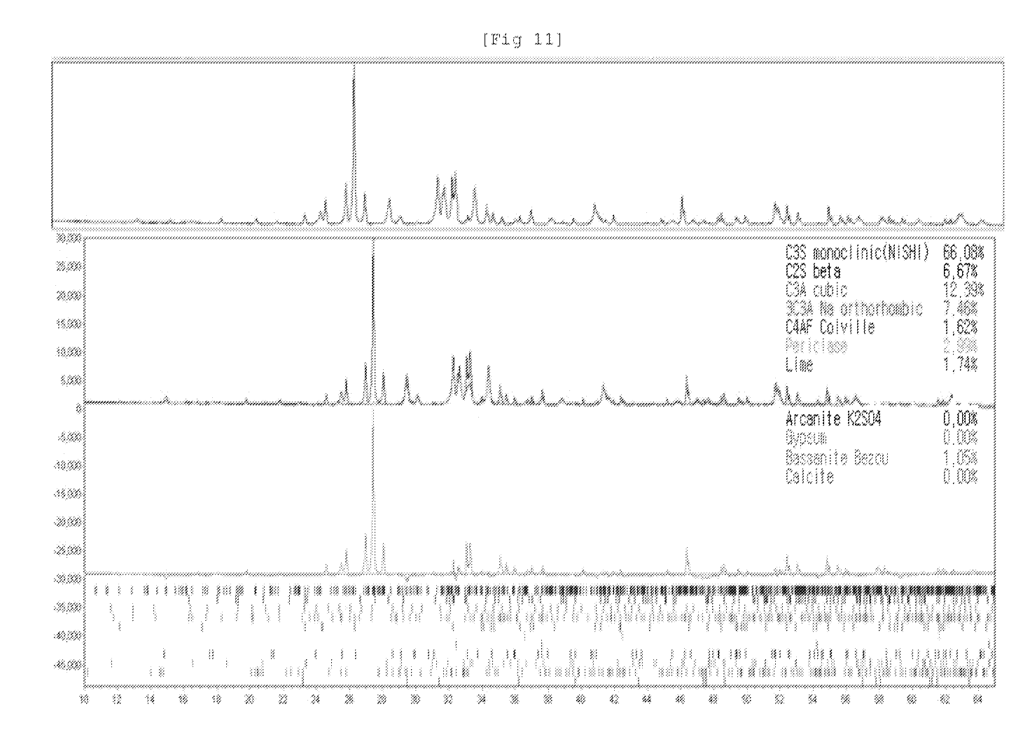

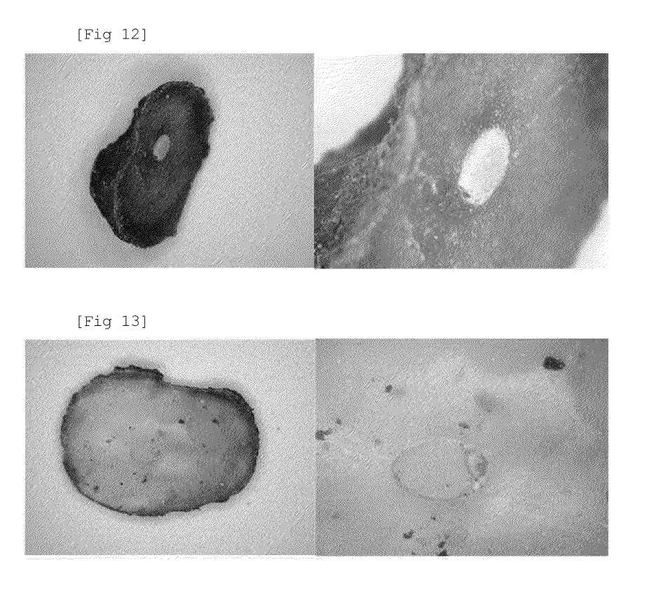

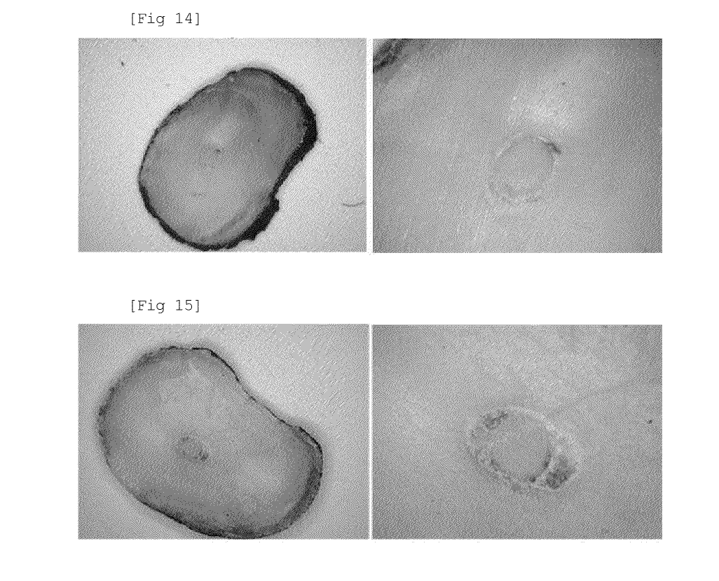

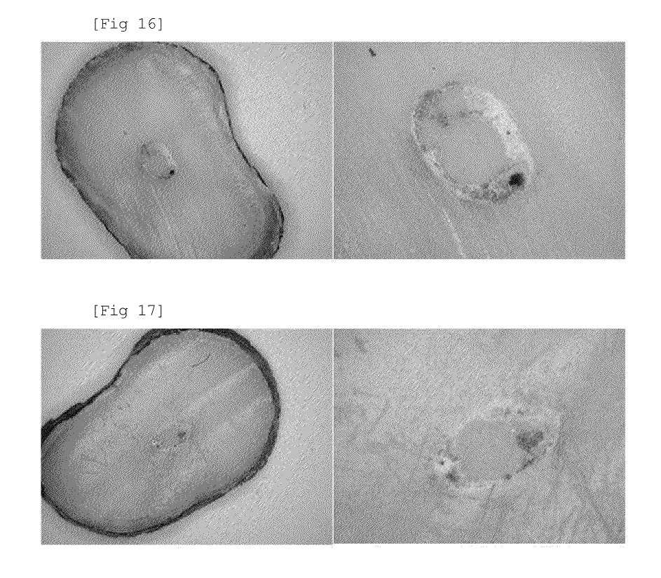

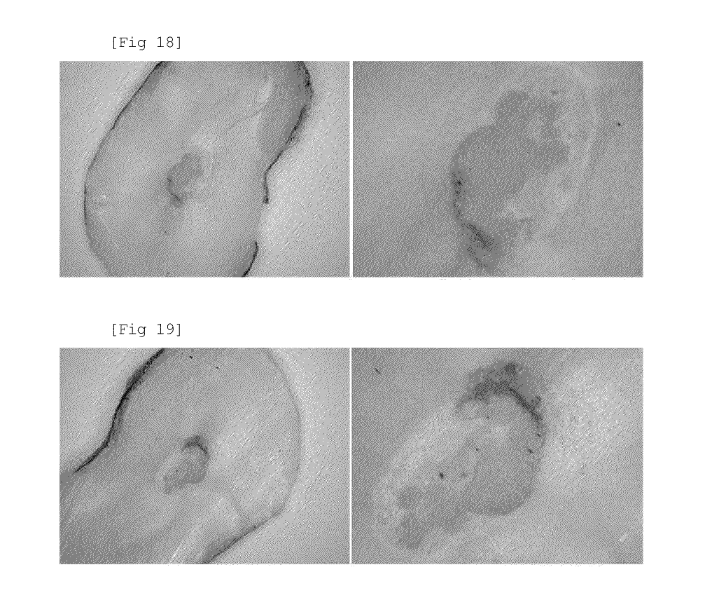

FIGS. 12 to 19 are optical micrographs showing the cross-sections of respective segments of the region at 1˜8 mm from the root apex. From these micrographs, infiltration and diffusion of the dyeing solution up to 8 mm from the root apex can be seen. 6 hours after canal filling, the root canal filler composed of conventional gutta percha and sealer can be seen to generate infiltration of the dyeing solution, and there is no root sealing effectiveness up to 8 mm from the root apex.

### Test Example 2

Root canal filling was conducted using ProRoot MTA available from DENTSPLY. Specifically, ProRoot MTA was mixed with water at a mixing ratio (water/powder) of 1 and then centrifuged using a centrifugal machine, after which the root canal filler mixture was charged in the root canal of a test tooth using a root canal filling tool. The root was immersed in a dyeing solution for 48 hours, and the cross-section thereof was observed.

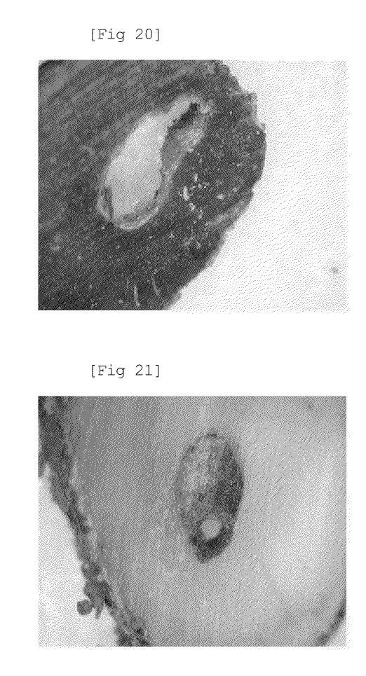

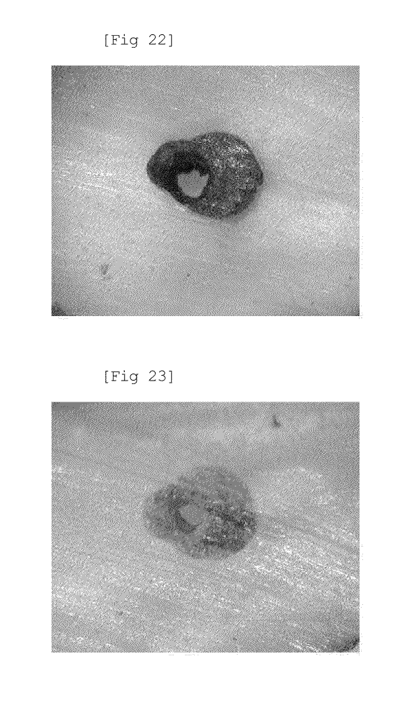

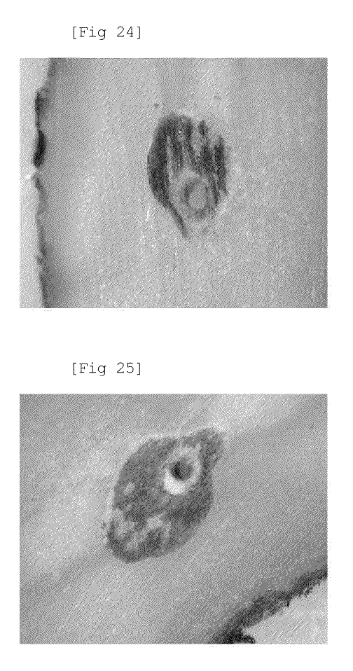

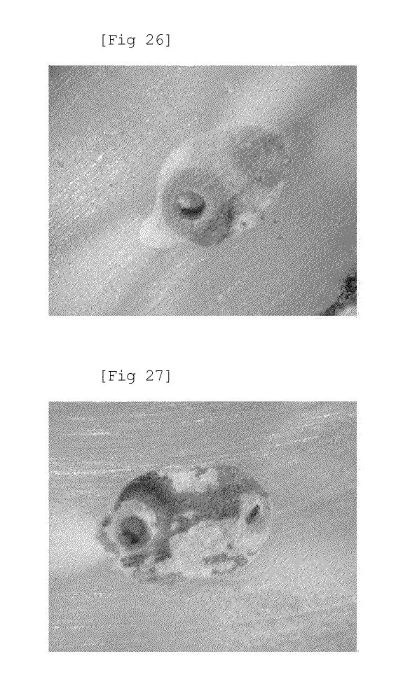

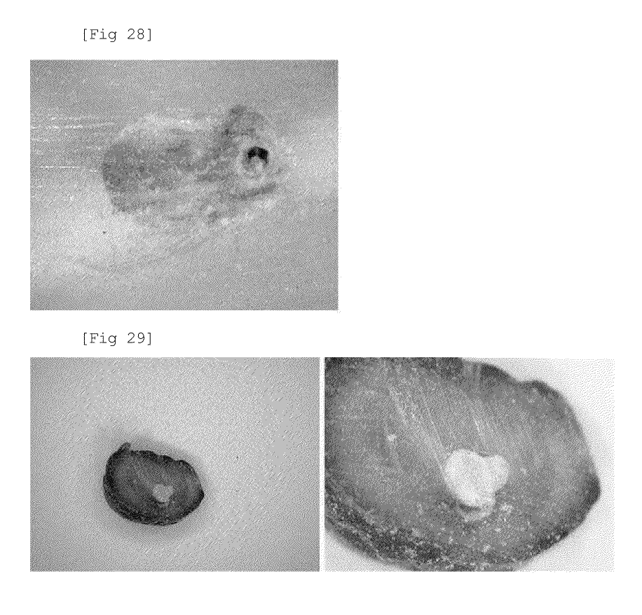

FIGS. 20 to 28 are optical micrographs showing cross-sections of respective segments at intervals of 1 mm from the root apex. In FIG. 20, the unsealed gap at 1 mm from the root apex is observed, and the unsealed gap and the infiltration of the dyeing solution are seen at 2˜3 mm from the root apex (FIGS. 21 and 22). Furthermore, the unsealed gap is observed at 4˜9 mm from the root apex (FIGS. 23 to 28).

### Test Example 3

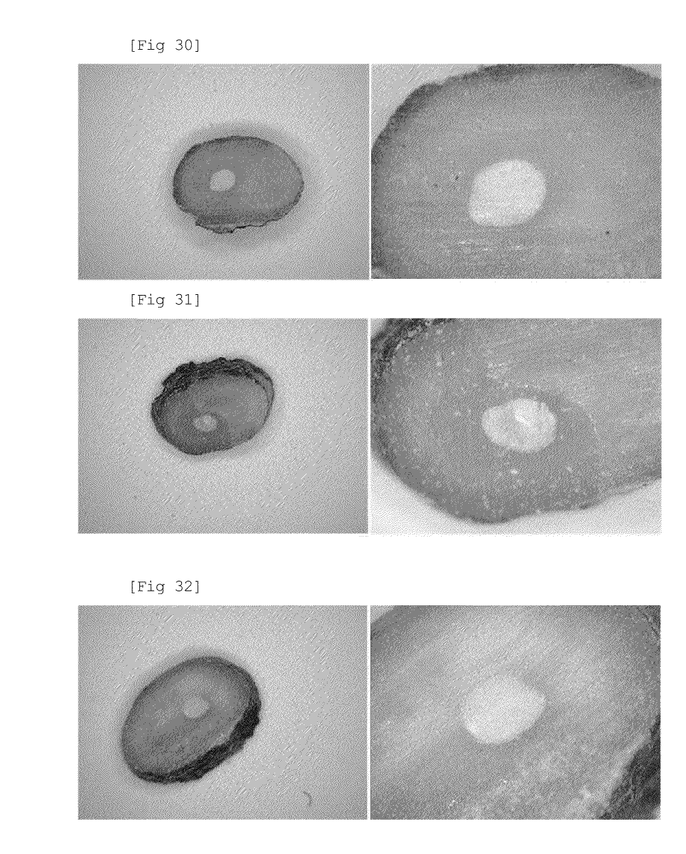

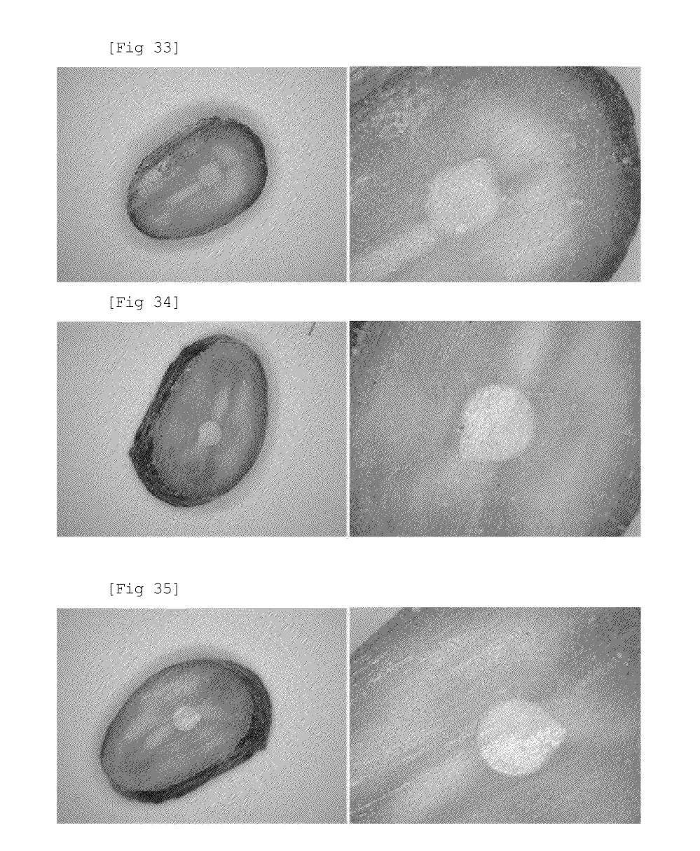

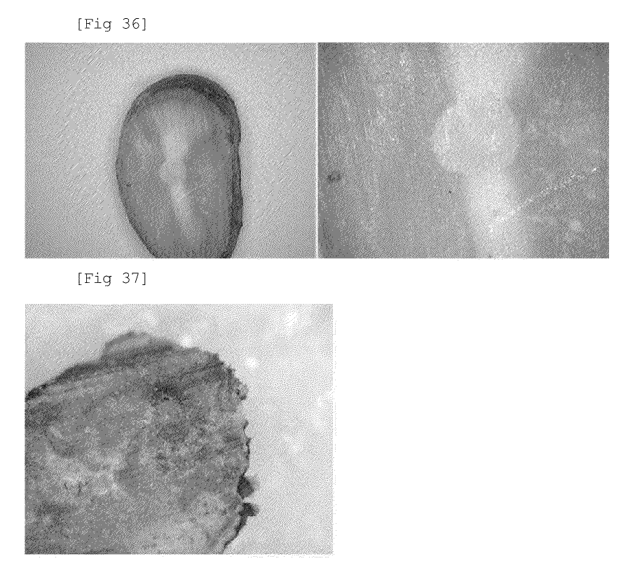

Root canal filling was carried out in the same manner as in Test Example 2 with the exception that the root canal filler of Example 1 was used. FIGS. 29 to 36 are optical micrographs showing the cross-sections of respective segments at intervals of 1 mm from the root apex. Although the infiltration of a small amount of dyeing solution is observed in the vicinity of 1 mm from the root apex (FIG. 29), the infiltration of the dyeing solution is not observed from the vicinity of 2 mm from the root apex (FIGS. 30 to 36), and also high sealing effectiveness can be seen to exhibit.

### Test Example 4

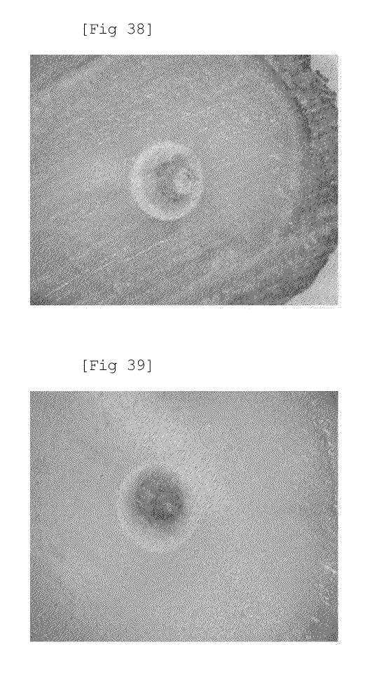

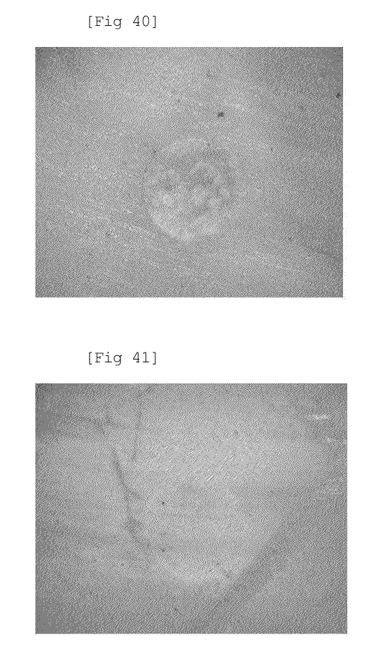

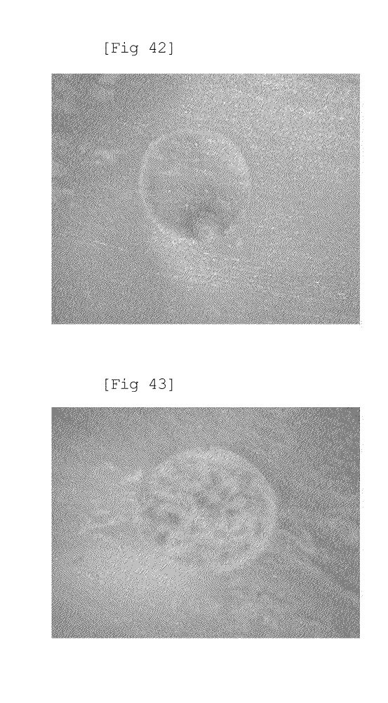

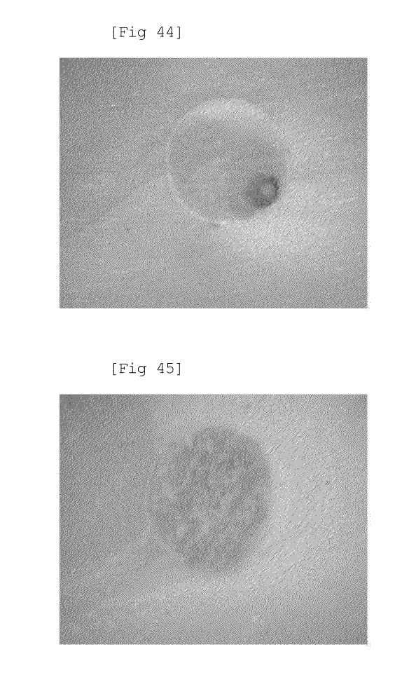

Root canal filling was carried out in the same manner as in Test Example 2 with the exception that the root canal filler of Example 2 was used. FIGS. 37 to 45 are optical micrographs showing the cross-sections of respective segments at 1˜9 mm from the root apex. The infiltration of a small amount of dyeing solution in the vicinity of 1 mm from the root apex is observed (FIG. 37), but the infiltration of the dyeing solution is not observed from 2 mm from the root apex (FIGS. 30 to 36), and also very high sealing effectiveness can be seen to exhibit.

In order to serve as a root canal filler, complete sealing effectiveness should be exhibited in the region to 3 mm from the root apex. However, conventional root canal filler such as gutta percha and sealer or ProRoot is poor in terms of such sealing effectiveness and is thus inappropriate for use in orthograde canal filling. In the case of ProRoot, it is disadvantageous because it has an average particle size of about 6.9 μm and includes irregularly mixed coarse particles much larger than 10 μm, and thus such large particles may abruptly block the root canal in the course of filling and may also form a gap in the root canal to be sealed, undesirably forming a place where bacteria may live in the region to 3 mm from the root apex. Consequently, the success rate of root canal treatment cannot increase. However, the root canal fillers of Examples 1 to 4 according to the present invention have an average particle size of about 5 μm or less with a uniform particle size distribution, thus exhibiting high sealing effectiveness to 3 mm from the root apex and preventing the formation of a gap in the filled root canal. Thereby, an increase in the success rate of clinical endodontic treatment may be achieved. This is because the gap, corresponding to a place where anaerobic bacteria propagate and where the application of an antibiotic material is impossible, is not provided in the root canal.

ProRoot, which has been developed to fill a relatively large cavity having a diameter of about 1 mm and a depth of about 3 mm resulting from retrograde canal filling accompanied by a surgical operation such as apicoectomy, has a large particle size unsuitable for filling and sealing the fine root canal having a diameter of about 0.25˜0.35 mm upon orthograde canal filling. The ProRoot product has a large average particle size of 6.9 μm and a large standard deviation for the average particle size, with coarse particles, and is thus difficult to handle in the course of canal sealing and cannot but form many gaps in the root canal after sealing, resulting in unsatisfactory sealing effectiveness.

As described hereinbefore, the present invention provides a root canal filler composed of MTA and a method of manufacturing the same. According to the present invention, when the root canal filler is applied to orthograde canal filling, it can hermetically seal the region to 5 mm from the root apex. Also, the root canal filler, having low residual CaO content, can prevent root fracture from occurring due to expansion after treatment. Also, the root canal filler composed of MTA is provided in the form of powder having high crystalline phase content, and is of very low impurity, thus completely excluding components hazardous to the human body.

Also, the root canal filler can be easily introduced and thus exhibit improved filling workability, and includes a radiopaque material harmless to the human body. The novel powdery root canal filler composed of MTA according to the present invention can be enhanced in terms of mechanical and physical properties, and accelerates the differentiation of blast cells and is thus very effective in aiding the treatment of the apical region.

Although the embodiments of the present invention have been disclosed for illustrative purposes, those skilled in the art will appreciate that a variety of different modifications, additions and substitutions are possible, without departing from the scope and spirit of the invention as disclosed in the accompanying claims. Accordingly, such modifications, additions and substitutions should also be understood as falling within the scope of the present invention.

1. A root canal filler, which is powdery and comprises a mineral trioxide aggregate comprising a CaO—SiO2-Al2O3 compound, and in which residual CaO content is 1.5 wt % or less.

2. The root canal filler according to claim 1, which comprises as main components 3CaO.SiO2,2CaO.SiO2 and 3CaO.Al2O3, these components being used in an amount of 95 wt % or more based on total weight of the CaO—SiO2-Al2O3 compound.

3. The root canal filler according to claim 1, further comprising a radiopaque material selected from the group consisting of ytterbium fluoride, strontium glass, barium glass, barium sulfate, and bismuth trioxide.

4. The root canal filler according to claim 1, wherein the residual CaO content is 0.7 wt % or less.

5. The root canal filler according to claim 1, wherein an average particle size is 1˜5 μm and a maximum particle size is 10 μm or less.

6. The root canal filler according to claim 1, wherein an average particle size is 0.1˜2 μm and a maximum particle size is 5 μm or less.

7. The root canal filler according to claim 1, wherein dimensional change following setting is 0.1% or less.

8. An orthograde canal filling method, comprising:
enlarging a root canal of a tooth;
mixing water with a root canal filler which is powdery and comprises a mineral trioxide aggregate comprising a CaO—SiO2-Al2O3 compound and in which residual CaO content is 1.5 wt % or less, thus obtaining a mixture, and then centrifuging the mixture, thus obtaining a centrifuged root canal filler;
pushing the centrifuged root canal filler toward a root apex through a canal orifice, thus sealing the root apex;
filling the root canal with the root canal filler; and
setting the root canal filler.

9. The method according to claim 8, wherein the root canal filler comprises as main components 3CaO.SiO2,2CaO.SiO2 and 3CaO.Al2O3, these components being used in an amount of 95 wt % or more based on total weight of the CaO—SiO2-Al2O3 compound.

10. The method according to claim 8, wherein the root canal filler further comprises a radiopaque material selected from the group consisting of ytterbium fluoride, strontium glass, barium glass, barium sulfate, and bismuth trioxide.

11. The method according to claim 8, wherein the root canal filler has the residual CaO content of 0.7 wt % or less.

12. The method according to claim 8, wherein the root canal filler has an average particle size of 1˜5 μm and a maximum particle size of 10 μm or less.

13. The method according to claim 8, wherein the root canal filler has an average particle size of 0.1˜2 μm and a maximum particle size of 5 μm or less.

14. The root canal filler according to claims 2, wherein dimensional change following setting is 0.1% or less.

15. The root canal filler according to claims 3, wherein dimensional change following setting is 0.1% or less.

16. The root canal filler according to claims 4, wherein dimensional change following setting is 0.1% or less.

17. The root canal filler according to claims 5, wherein dimensional change following setting is 0.1% or less.

18. The root canal filler according to claims 6, wherein dimensional change following setting is 0.1% or less.
